(19) United States
(12) Patent Application Publication
(10) Pub. No.: US 2026/0288436 A1
(43) Pub. Date: Sep. 24, 2026

(54) METHOD AND SYSTEM OF IMPLEMENTING AT LEAST ONE GENERATIVE ARTIFICIAL INTELLIGENCE AGENT INTAKE AND DEPLOYMENT DEPOT

(71) Applicant: JPMorgan Chase Bank, N.A., New York, NY (US)

(72) Inventors: Bijan VAFAEI, Burr Ridge, IL (US); Anupam ARORA, Middletown, DE (US); Daniel HALVERSON, Aurora, IL (US); David CASTILLO, Gilbert, AZ (US); Ilan SELINGER, Walnut Creek, CA (US); John ROLLINS, Cocoa, FL (US); Shashanka NARAYAN, Chicago, IL (US); Sandhya KODALI, Frisco, TX (US); Roy THARPE, Merritt Island, FL (US); Kiran PURUSHOTHAM, Allen, TX (US); Ryan EAVY, Chicago, IL (US); Alex BABB, Chicago, IL (US); Anjaiah METHUKU, Media, PA (US); Bhavendrarao CHAVAN, Lake Hiawatha, NJ (US); Srikanth KODALI, Frisco, TX (US)

(73) Assignee: JPMorgan Chase Bank, N.A., New York, NY (US)

(21) Appl. No.: 19/085,448

(22) Filed: Mar. 20, 2025

(51) Int. Cl. G06F 8/60; G06F 9/451; G06F 21/44

(52) U.S. Cl. CPC G06F 8/60; G06F 9/451; G06F 21/44

(57) ABSTRACT

A system of implementing a generative artificial intelligence (GenAI) agent intake and deployment depot. The system may be configured to: receive a first set of electronic transmissions that comprises a first set of code which implements a first GenAI agent that is configured to perform a first set of tasks; store the first set of code within a GenAI repository; index, within an electronic manifest of the GenAI repository, a first set of details that pertain to the first GenAI agent; and utilize at least a portion of the electronic manifest to provide, to at least one network device of an electronic communication network, access to at least the first GenAI agent from among a set of GenAI agents that is stored within the GenAI repository.

### BACKGROUND

### 1. Field

This disclosure generally relates to generative artificial intelligence (GenAI) and, more particularly, to a method, system, and computer-readable medium for implementing at least one GenAI agent intake and deployment depot.

### 2. Background

The artificial intelligence industry is booming due to recent technological advancements that have caused this industry to grow at an exponential rate over the past few years. As a result, artificial intelligence technology is now changing the way that we live by impacting just about everything that we do.

However, conventional software management tools cannot be utilized to manage artificial intelligence solutions effectively, because of the unique nature (e.g., algorithmic modeling, etc.) and/or unique structure (e.g., large datasets, etc.) of artificial intelligence solutions. As a result, the management of artificial intelligence solutions requires the development of new tools and infrastructures that are not yet available in today's marketplace.

Therefore, there is a need in the field of the present disclosure, for an improvement that provides for the management of today's artificial intelligence solutions.

Accordingly, the approach disclosed herein is presented to improve the field of the present disclosure by addressing the above-mentioned technical problems that exist in today's artificial intelligence industry.

### SUMMARY

The present disclosure, through one or more of its various aspects, embodiments, and/or specific features or sub-component, provides, inter alia, various systems, servers, devices, methods, media, programs and platforms for implementing at least one generative artificial intelligence (GenAI) agent intake and deployment depot.

According to an aspect of the invention, a method is provided that implements a GenAI agent intake and deployment depot. The method may comprise: receiving a first set of electronic transmissions that comprises a first set of code that implements a first GenAI agent which includes at least a first GenAI model that comprises a first set of algorithms which are configured to perform, collectively, a first set of tasks; storing the first set of code within a GenAI repository; indexing, within an electronic manifest of the GenAI repository, a first set of details that pertain to the first GenAI agent; and utilizing at least a portion of the electronic manifest to provide, to at least one network device of an electronic communication network, access to at least the first GenAI agent from among a set of GenAI agents that is stored within the GenAI repository.

In the method, providing the access may comprise providing the first GenAI agent to the electronic communication network by performing at least one operation from among: deploying a remote instance of the first GenAI agent to the at least one network device; and interfacing, via at least one application programing interface (API), a local instance of the first GenAI agent with the at least one network device.

The method may further comprise at least one from among: authenticating the first GenAI agent after the first set of code is received; and verifying, before an instance of the first GenAI agent is accessed, that the first GenAI agent has been authenticated.

The method may further comprise delegating a first set of system resources to at least one instance of the first GenAI. The first set of system resources may comprise at least one from among at least one hardware resource and at least one software resource.

In the method, providing the access may comprise performing at least one operation from among: permitting the at least one network device to instruct the first GenAI agent to generate and return a first set of responses to a first set of respectively corresponding queries that have been received from the at least one network device; permitting the at least one network device to at least one from among test and evaluate at least one performance of the first GenAI agent; and permitting the at least one network device to at least one from among search the GenAI repository for a GenAI agent from among the set of GenAI agents, and deploy from the GenAI repository, at least one instance of the GenAI agent, to the at least one network device.

In the method, providing the access may comprise performing at least one operation from among: permitting the at least one network device to generate an updated set of code by updating the first set of code according to at least one software patch that fixes at least one bug of the first GenAI agent; and permitting the at least one network device to generate a second GenAI agent by modifying the first set of code.

The method may further comprise propagating the software patch to at least one instance of the first GenAI agent to which the at least one network device has been provided the access.

The method may further comprise orchestrating, according to at least one orchestration pattern, a plurality of GenAI agents to perform, collectively, at least one task.

In the method, providing the access may comprise utilizing a graphical user interface (GUI) to provide the at least one network device with the access. The GUI may comprise at least one depiction of GenAI agent activity, and the GUI may provide GenAI agent control by enabling each from among the at least one depiction to be selected and configured, individually.

In the method, providing the access may comprise permitting the at least one network device to wipe at least one instance of the first GenAI agent from at least one from among the GenAI repository and a set of network devices within the electronic communication network.

According to another aspect of the present disclosure, a system is provided that implements a GenAI agent intake and deployment depot. The system may comprise a processor and memory that stores instructions which, when executed by the processor, cause the processor to perform operations that may comprise: receiving a first set of electronic transmissions that comprises a first set of code that implements a first GenAI agent which includes at least a first GenAI model that comprises a first set of algorithms which are configured to perform, collectively, a first set of tasks; storing the first set of code within a GenAI repository; indexing, within an electronic manifest of the GenAI repository, a first set of details that pertain to the first GenAI agent; and utilizing at least a portion of the electronic manifest to provide, to at least one network device of an electronic communication network, access to at least the first GenAI agent from among a set of GenAI agents that is stored within the GenAI repository.

In the system, when executed by the processor, the instructions may cause providing the access to comprise providing the first GenAI agent to the electronic communication network by performing at least one operation from among: deploying a remote instance of the first GenAI agent to the at least one network device; and interfacing, via at least one API, a local instance of the first GenAI agent with the at least one network device.

In the system, wherein when executed, the instructions may cause the processor to perform further operations, which may comprise at least one from among: authenticating the first GenAI agent after the first set of code is received; and verifying, before an instance of the first GenAI agent is accessed, that the first GenAI agent has been authenticated.

In the system, when executed, the instructions may cause the processor to perform further operations, which may comprise delegating a first set of system resources to at least one instance of the first GenAI. The first set of system resources may comprise at least one from among at least one hardware resource and at least one software resource.

In the system, when executed by the processor, the instructions may cause providing the access to comprise performing at least one operation from among: permitting the at least one network device to instruct the first GenAI agent to generate and return a first set of responses to a first set of respectively corresponding queries that have been received from the at least one network device; permitting the at least one network device to at least one from among test and evaluate at least one performance of the first GenAI agent; and permitting the at least one network device to at least one from among search the GenAI repository for a GenAI agent from among the set of GenAI agents, and deploy from the GenAI repository, at least one instance of the GenAI agent, to the at least one network device.

In the system, when executed by the processor, the instructions may cause providing the access to comprise performing at least one operation from among: permitting the at least one network device to generate an updated set of code by updating the first set of code according to at least one software patch that fixes at least one bug of the first GenAI agent; and permitting the at least one network device to generate a second GenAI agent by modifying the first set of code.

In the system, when executed, the instructions may cause the processor to perform further operations, which may further comprise propagating the software patch to at least one instance of the first GenAI agent to which the at least one network device has been provided the access.

In the system, when executed, the instructions may cause the processor to perform further operations, which may further comprise orchestrating, according to at least one orchestration pattern, a plurality of GenAI agents to perform, collectively, at least one task.

In the system, when executed by the processor, the instructions may cause providing the access to comprise utilizing a GUI to provide the at least one network device with the access. The GUI may comprise at least one depiction of GenAI agent activity, and the GUI may provide GenAI agent control by enabling each from among the at least one depiction to be selected and configured, individually.

In the system, when executed by the processor, the instructions may cause providing the access to comprise permitting the at least one network device to wipe at least one instance of the first GenAI agent from at least one from among the GenAI repository and a set of network devices within the electronic communication network.

According to yet another aspect of the present disclosure, a non-transitory computer-readable medium is provided that implements a GenAI agent intake and deployment depot. The computer-readable medium may store instructions that, when executed by a processor, cause the processor to perform operations that comprise: receiving a first set of electronic transmissions that comprises a first set of code that implements a first GenAI agent which includes at least a first GenAI model that comprises a first set of algorithms which are configured to perform, collectively, a first set of tasks; storing the first set of code within a GenAI repository; indexing, within an electronic manifest of the GenAI repository, a first set of details that pertain to the first GenAI agent; and utilizing at least a portion of the electronic manifest to provide, to at least one network device of an electronic communication network, access to at least the first GenAI agent from among a set of GenAI agents that is stored within the GenAI repository.

In the computer-readable medium, when executed by the processor, the instructions may cause providing the access to comprise providing the first GenAI agent to the electronic communication network by performing at least one operation from among: deploying a remote instance of the first GenAI agent to the at least one network device; and interfacing, via at least one API, a local instance of the first GenAI agent with the at least one network device.

In the computer-readable medium, when executed, the instructions may cause the processor to perform further operations, which may comprise at least one from among: authenticating the first GenAI agent after the first set of code is received; and verifying, before an instance of the first GenAI agent is accessed, that the first GenAI agent has been authenticated.

In the computer-readable medium, when executed, the instructions may cause the processor to perform further operations, which may comprise delegating a first set of system resources to at least one instance of the first GenAI, wherein the first set of system resources comprises at least one from among at least one hardware resource and at least one software resource.

In the computer-readable medium, when executed by the processor, the instructions may cause providing the access to comprise performing at least one operation from among: permitting the at least one network device to instruct the first GenAI agent to generate and return a first set of responses to a first set of respectively corresponding queries that have been received from the at least one network device; permitting the at least one network device to at least one from among test and evaluate at least one performance of the first GenAI agent; and permitting the at least one network device to at least one from among search the GenAI repository for a GenAI agent from among the set of GenAI agents, and deploy from the GenAI repository, at least one instance of the GenAI agent, to the at least one network device.

In the computer-readable medium, when executed by the processor, the instructions may cause providing the access to comprise performing at least one operation from among: permitting the at least one network device to generate an updated set of code by updating the first set of code according to at least one software patch that fixes at least one bug of the first GenAI agent; and permitting the at least one network device to generate a second GenAI agent by modifying the first set of code.

In the computer-readable medium, when executed, the instructions may cause the processor to perform further operations, which may further comprise propagating the software patch to at least one instance of the first GenAI agent to which the at least one network device has been provided the access.

In the computer-readable medium, when executed, the instructions may cause the processor to perform further operations, which further may comprise orchestrating, according to at least one orchestration pattern, a plurality of GenAI agents to perform, collectively, at least one task.

In the computer-readable medium, when executed by the processor, the instructions may cause providing the access to comprise utilizing a GUI to provide the at least one network device with the access. The GUI may comprise at least one depiction of GenAI agent activity, and the GUI may provide GenAI agent control by enabling each from among the at least one depiction to be selected and configured, individually.

The computer-readable medium, when executed by the processor, the instructions may cause providing the access to comprise permitting the at least one network device to wipe at least one instance of the first GenAI agent from at least one from among the GenAI repository and a set of network devices within the electronic communication network.

Accordingly, the invention disclosed herein provides a GenAI agent intake and deployment depot.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of computer system, according to an embodiment.

FIG. 2 depicts a diagram of an environment for implementing at least one GenAI agent intake and deployment depot, according to an embodiment.

FIG. 3 depicts a diagram of an aspect of an environment that is configured to implement at least one GenAI agent intake and deployment depot, according to an embodiment.

FIG. 4 depicts a flowchart of at least one GenAI agent intake and deployment depot, according to an embodiment.

FIG. 5 depicts a diagram of an implementation of a GenAI agent intake and deployment depot, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out operations necessary to implement the methods of the examples of this technology that are described and illustrated herein.

As described in further detail below, the herein-disclosed technology implements a generative artificial intelligence (GenAI) agent intake and deployment depot.

Accordingly, by employing the herein-disclosed technique within one or more electronic communication networks and thereby providing network-wide access to a repository of GenAI agents, the technique disclosed herein enables network-wide management, development and application of one or more GenAI agents from among the repository of GenAI agents.

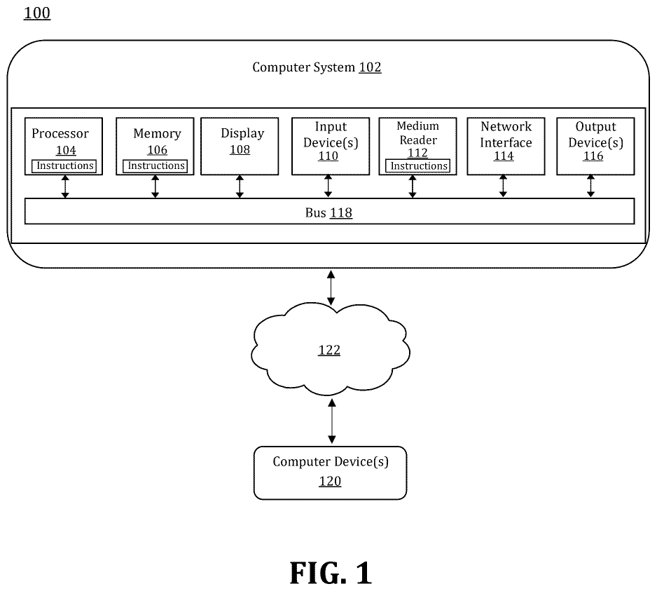

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described in further detail below, the various embodiments disclosed herein provide methods, systems and computer-readable media for implementing a GenAI agent intake and deployment depot that enables network-wide management, development and application of one or more GenAI agents from among a repository of GenAI agents.

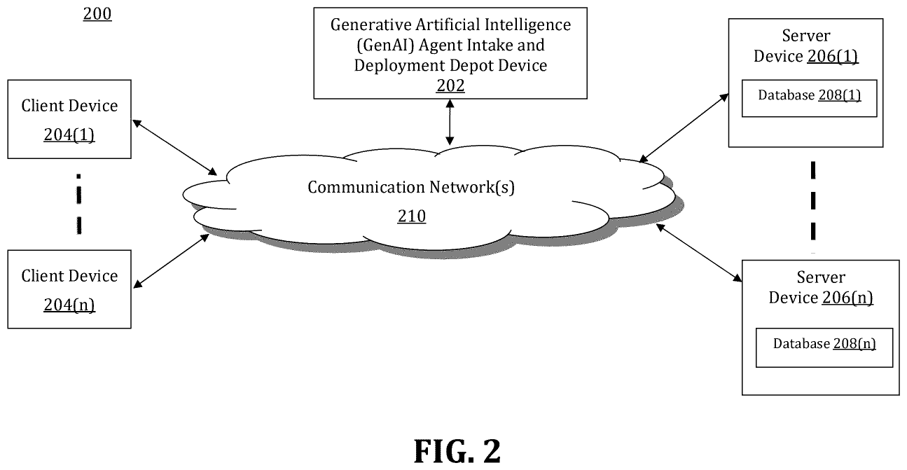

Referring to FIG. 2, a schematic of a network environment 200 for implementing a GenAI agent intake and deployment depot. In an embodiment, the GenAI agent intake and deployment depot may be implemented on any networked computer platform, such as, for example, a personal computer (PC).

A method of enabling network-wide management, development and application of one or more GenAI agents from among a repository of GenAI agents, may be implemented by a GenAI agent intake and deployment depot (GAID) device 202. The GAID device 202 may be the same or similar to the computer system 102 as described with respect to FIG. 1. The GAID device 202 may be a rack-mounted server in a datacenter, an embedded microcontroller (MCU) in an electronic device, or another type of headless system, which is a computer system or device that is configured to operate without a monitor, keyboard and mouse. The GAID device 202 may store one or more applications that can include executable instructions that, when executed by the GAID device 202, cause the GAID device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the GAID device 202 itself, may be located in virtual server(s) running in a cloud-based computing environment rather than being tied to one or more specific physical network computing devices. Also, the application(s) may be running in one or more virtual machines (VMs) executing on the GAID device 202. Additionally, in one or more embodiments of this technology, virtual machine(s) running on the GAID device 202 may be managed or supervised by a hypervisor.

In the network environment 200 of FIG. 2, the GAID device 202 is coupled to a plurality of client devices 204(1)-204(n), and also to a plurality of server devices 206(1)-206(n) that hosts a plurality of databases 208(1)-208(n) via communication network(s) 210. A communication interface of the GAID device 202, such as the network interface 114 of the computer system 102 of FIG. 1, operatively couples and communicates between the GAID device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GAID device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and GAID devices that implement a method for a GenAI agent intake and deployment depot that enables network-wide management, development and application of one or more GenAI agents from among the repository of GenAI agents.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The GAID device 202 may be a standalone device or integrated with one or more other devices or apparatuses, such as one or more of the server devices 206(1)-206(n), for example. In one particular example, the GAID device 202 may include or be hosted by one of the server devices 206(1)-206(n), and other arrangements are also possible. As another example, the GAID device 202 may be integrated with one or more other devices or apparatuses, such as one or more of the client devices 204(1)-204(n). Moreover, one or more of the devices of the GAID device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the GAID device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the GAID device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204(n) may run interface applications, such as standard web browsers or standalone client applications, which may provide an interface to communicate with the GAID device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured against eavesdropping, and these applications may be distributed among client devices 204(1)-204(n). The enterprise's distributed applications may include software that is based on microservices architecture, for example.

Although the network environment 200 with the GAID device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the GAID device 202, the client devices 204(1)-204(n), the server devices 206(1)-206(n), and the databases 208(1)-208(n), for example, may be configured to operate as virtual instances on the same physical machine. In other words, one or more of the GAID device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

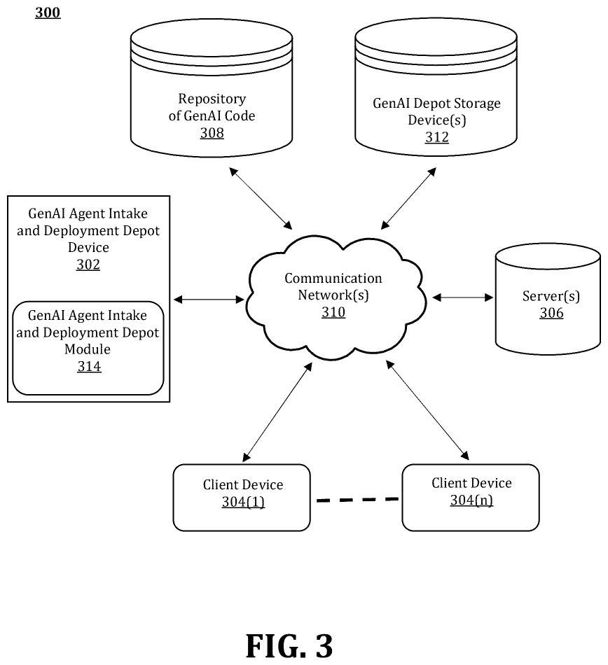

The GAID device 302 is described and illustrated in FIG. 3 as including GenAI agent intake and deployment depot module 314, although it may include other rules, policies, modules, databases, or applications, for example. As will be described below, GenAI agent intake and deployment depot module 314 is configured to implement at least one GAID within at least one electronic communication network, such as communication network(s) 310, for example. GenAI agent intake and deployment depot module 314 may include software that is based on microservices architecture, for example.

GenAI agent intake and deployment depot module 314 may be integrated with one or more devices or apparatuses, such as client devices 304(1)-304(n), where GenAI agent intake and deployment depot module 314 may be implemented as an application or as an addon or plugin to another application of the one or more devices or apparatuses, and where GenAI agent intake and deployment depot module 314 may execute in the background.

A configuration 300 for implementing a GAID within an aspect of the network environment of FIG. 2 is illustrated as being executed in FIG. 3. Specifically, client devices 304(1)-304(n) are illustrated as being in communication with GAID device 302. In this regard, a first client device 304(1) and at least a second client device 304(2) may be “clients” of the GAID device 302 and are described herein as such. Nevertheless, it is to be known and understood that client device 304(1) and/or at least client device 304(2) need not necessarily be “clients” of the GAID device 302, or any entity described in association therewith herein. Any additional or alternative relationship may exist between client device 304(1), client device 304(2) and GAID device 302.

GenAI agent intake and deployment depot module 314 of GAID device 302 may communicate with at least one database and/or repository, such as one or more repositories of GenAI code 308. Thereby, as described in further detail below, GAID device 302 may utilize one or more local and/or network repositories to store at least one from among executable code (e.g., code), metadata, parameters, features, attributes, algorithms, software, datasets and/or other information for implementing at least one GenAI agent within at least one electronic communication network.

In addition, GenAI agent intake and deployment depot module 314 of GAID device 302 may communicate with at least one database and/or repository, such as one or more GenAI depot storage device(s) 312. Thereby, as described in further detail below, GAID device 302 may obtain, from GenAI depot storage device(s) 312, at least one from among executable code (e.g., code), metadata, parameters, features, attributes, algorithms, software, datasets and/or other information for implementing and executing a GAID such as GenAI agent intake and deployment depot module 314.

In an embodiment, GenAI agent intake and deployment depot module 314 may be configured to provide a dynamically customizable interface for selecting, to communicate with, at least one server device from among one or more server device 306, which may comprise server devices 306(1)-306(n). Moreover, GAID device 302 may receive and transmit data via communication network(s) 210. GAID device 302 may receive and transmit data such as code that is written in one or more of the following dialects: transaction control language (TCL), data manipulation language (DML), data control language (DCL) and data definition language (DDL). Additionally, via communication network(s) 310, GAID device 302 may respectively receive and transmit data from and to one or more from among client devices 304(1)-304(n) and the server devices 306(1)-306(n).

However, FIG. 3 depicts client device 304(1) and at least client device 304(n) as belonging to communication network(s) 310, and GAID device 302 may communicate with any one or more devices or apparatuses that belong to the communication network(s) 310, such as one or more from among client devices 304(1)-304(n). For example, GAID device 302 may utilize a graphical user interface (GUI) to communicate with one or more from among client devices 304(1)-304(n), and communication network(s) 310 may comprise a cluster that belongs to the above-mentioned enterprise that may be secured against eavesdropping. In a further embodiment, communication network(s) 310 may comprise a cluster of distributed applications that belong to the enterprise.

Client device 304(1) may be, for example, a smart phone. Of course, client device 304(1) may be any additional device described herein. Client device 304(n) may be, for example, a personal computer (PC). Of course, client device 304(n) may also be any additional device described herein.

The client devices 304(1)-304(n) may represent, for example, computer systems of the enterprise's client network. Client device 304(1) may represent, for example, one or more computer systems of a client or of a cluster of clients within the enterprise or client network. Of course, client device 304(1) may include one or more of any of the devices described herein. Client device 304(n) may be, for example, one or more computer systems of another client or cluster of clients within the enterprise or client network. Of course, client device 304(n) may include one or more of any of the devices described herein.

The herein-disclosed process(es) may be executed via the communication network(s) 310, which may comprise plural networks as described above. For example, in an embodiment, either or both of client device 304(1) and client device 204(n) may communicate with the GAID device 302 via broadband or cellular communication. Of course, these embodiments are merely exemplary and are not limiting or exhaustive.

GenAI agent intake and deployment depot module 314 may programmatically configure, and communicate with, client devices 304(1)-304(n) which may respectively correspond to one or more remote clusters of endpoints, for example.

GenAI agent intake and deployment depot module 314 may execute at least one process that programmatically onboards, manages and deploys a set of GenAI agents within at least one electronic communication network. In some embodiments, GenAI agent intake and deployment depot module 314 may execute the at least one process to onboard GenAI agents from, and/or deploy them to, at least one (and possibly each) from among client devices 304(1)-304(n) and server devices 306(1)-306(n).

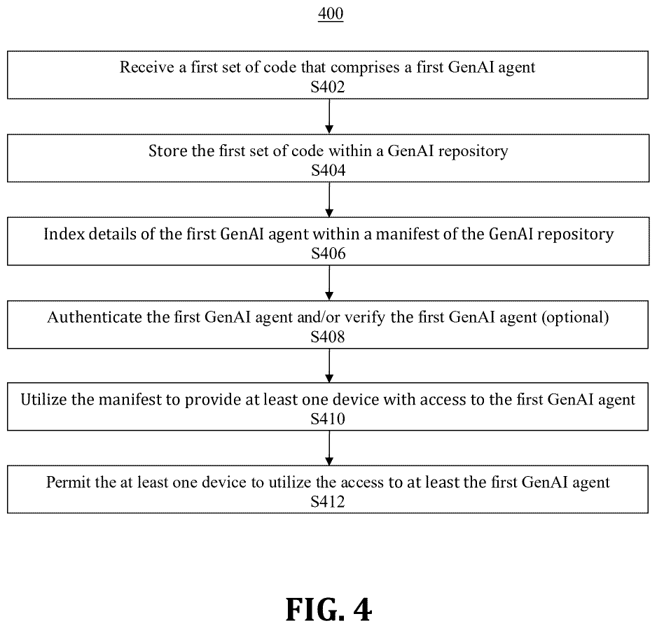

A process for a GenAI agent intake and deployment depot is generally indicated at flowchart 400 in FIG. 4. Process 400 may be executed to at least one from among onboard, manage and deploy at least one GenAI agent within the at least one electronic communication network.

At step S402, the GenAI agent intake and deployment depot (such as GenAI agent intake and deployment depot 202, GenAI agent intake and deployment depot device 302 and/or GenAI agent intake and deployment depot module 314) may receive a first set of electronic transmissions. The first set of electronic transmissions may comprise a first set of code that implements a first GenAI agent, and the first GenAI agent may include at least a first GenAI model that comprises a first set of algorithms which are configured to perform, collectively, a first set of tasks.

At step S404, the GenAI agent intake and deployment depot may store the first set of code within a GenAI agent repository, such as repository of GenAI code 308, which may comprise a database such as 208(1) that is configured to store a set of GenAI agents. The set of GenAI agents may comprise one GenAI agent or a plurality of GenAI agents, each of which may be independently stored by the GenAI repository as a distinct set of code (or a distinct version of distinct sets of code), namely a distinct set of instructions that when executed by a computer processor, cause the computer processor to perform a corresponding GenAI agent's function(s).

The GenAI repository, such as repository of GenAI code 308, may also comprise a plurality of repositories or databases, such as database devices 208(1)-208(n), for example. Each repository or database from among the repositories or databases may be configured to store a distinct plurality of GenAI agents. Thereby, collectively, such GenAI repositories may be configured to store a vast total quantity of distinct GenAI agents.

At step S406, the GenAI agent intake and deployment depot may index, within an electronic manifest of the GenAI repository, a first set of details that pertain to the first GenAI agent. The first set of details that pertain to the first GenAI agent may comprise attributes of the first set of code, and the attributes of the first set of code may comprise at least one from among size, location, metadata, dependencies, authentication data, etc.

Optionally, at step S408, the GenAI agent intake and deployment depot may authenticate the first GenAI agent after the first set of code is received, and/or the GenAI agent intake and deployment depot may verify that the first GenAI agent has been authenticated before an instance of the first GenAI agent is accessed. The GenAI agent intake and deployment depot may utilize first authentication data to evaluate and determine whether the first set of code is authentic. Accordingly, the GenAI agent intake and deployment depot may protect its system's integrity and security by discarding (or implementing proper precautions to mitigate any unwanted effects of) any set of code that turns out not to be authentic and untampered.

At step S410, the GenAI agent intake and deployment depot may utilize at least a portion of the electronic manifest to provide at least one network device of the at least one electronic communication network with access to at least the first GenAI agent from among a set of GenAI agents that is stored within the GenAI repository. During step S410, the GenAI agent intake and deployment depot may provide the access to the at least one network device by performing at least one of the following operations: (i) deploying at least one instance of the first GenAI agent to the at least one network device; and/or (ii) utilizing at least one API to interface the at least one network device with at least one from among at least the first set of code and/or at least one instance of the first GenAI agent.

At step S410, the GenAI agent intake and deployment depot may also perform at least one provisional operation to configure its system to provide the access to the at least one network device. More particularly, the GenAI agent intake and deployment depot may provision its systems to provide the access to the at least one network device by delegating a first set of system resources to the at least one instance of the first GenAI.

The first set of system resources may comprise at least one from among at least one hardware resource and at least one software resource, such as hardware resources that are provided by a system database and/or software resources that may be stored on such system database. The system database may comprise at least one from among: (i) a local database of the at least one network device; (ii) a local database of the GenAI agent intake and deployment depot; and/or (iii) a local database of another component within the system, such as GenAI depot storage device 312.

At step S412, the GenAI agent intake and deployment depot may provide the at least one network device with the access to the first GenAI agent, by performing at least one from among the following operations: (i) permitting the at least one network device to instruct the first GenAI agent to generate and return a first set of responses to a first set of respectively corresponding queries that have been received from the at least one network device; (ii) permitting the at least one network device to at least one from among test and evaluate at least one performance of the first GenAI agent; and/or (iii) permitting the at least one network device to perform at least one from among the following operations: (a) search the GenAI repository for at least one client-specified GenAI agent from among the set of GenAI agents; and (b) deploy at least one instance of the client-specified GenAI agent from the GenAI repository and to the at least one network device.

Additionally, or alternatively, at step S412, the GenAI agent intake and deployment depot may provide the access by performing further operations that include at least one from among: (i) permitting the at least one network device to generate an updated set of code by updating the first set of code according to at least one software patch that fixes at least one bug of the first GenAI agent; and (ii) permitting the at least one network device to generate a second GenAI agent by modifying the first set of code.

The GenAI agent intake and deployment depot may store the at least one software patch within at least one from among: (i) a local database of the at least one network device; (ii) a local database of the GenAI agent intake and deployment depot; and/or (iii) a local database of another component within the system, such as repository of GenAI code 308 and/or GenAI depot storage device 312.

Thereby, according to the disclosed invention(s), the GenAI agent intake and deployment depot may perform further operations, such as propagating the software patch to the at least one instance (or any other instance and/or combination of instances of the first GenAI agent to which the at least one network device has been provided the access).

The GenAI agent intake and deployment depot may also propagate the software patch to every instance of the first GenAI agent that has been deployed within the at least one electronic communication network. According to this approach, the GenAI agent intake and deployment depot may utilize at least one Internet protocol (IP) addressing scheme to propagate the software patch (or a plurality of software patches) to at least one client-specified target instance of the first GenAI agent (or any GenAI agent and/or combination of agents) from among the set of GenAI agents that is stored within the GenAI repository.

Additionally, or alternatively, the GenAI agent intake and deployment depot may also perform further operations that comprise utilizing at least one orchestration pattern to orchestrate a plurality of GenAI agents to perform, collectively, at least one task (e.g., at least one from among the first set of tasks and a second set of tasks). In a further embodiment, the GenAI agent intake and deployment depot may obtain (or receive) the at least one orchestration pattern from the at least one network device before orchestrating the plurality of GenAI agents.

According to the present invention(s), the GenAI agent intake and deployment depot may utilize a GUI (such as the GUI described above) to implement the approaches disclosed herein. Accordingly, the GenAI agent intake and deployment depot may generate and, subsequently, utilize at least one such GUI to perform at least one step or operation from among the above-mentioned steps S402-S412 of process 400.

Thereby, at step S412, the GenAI agent intake and deployment depot may also utilize a GUI to provide the access. The GUI may comprise at least one depiction of GenAI agent activity, and the GenAI agent intake and deployment depot may utilize the at least one depiction of GenAI agent activity to provide the at least one network device with the access by enabling the at least one network device to distinctly select and configure each GenAI agent (and each of their individual activities) from among the at least one depiction.

According to the present invention(s), at step S412, the GenAI agent intake and deployment depot may be utilized to provide the access by permitting the at least one network device(s) to develop the first (or any) GenAI agent. The at least one network device(s) may programmatically develop a GenAI agent (e.g., the first GenAI agent) by permitting edits and/or other modifications to the GenAI agent's corresponding set of code (e.g., the first set of code).

Additionally, or alternatively, at step S412, the GenAI agent intake and deployment depot may also provide the access by permitting the at least one network device to wipe, erase, delete, discard, remove, etc. at least one instance of the first GenAI agent from at least one from among the GenAI repository and/or a set of network devices within the electronic communication network. Thereby, step S412 may be utilized to eliminate any malicious, or otherwise undesired (e.g., GenAI agents that are not authentic) GenAI agents from the GenAI agent intake and deployment depot's system.

Accordingly, process 400 may be executed by the GenAI agent intake and deployment depot, to at least one from among onboard, manage and deploy at least one GenAI agent within at least one electronic communication network.

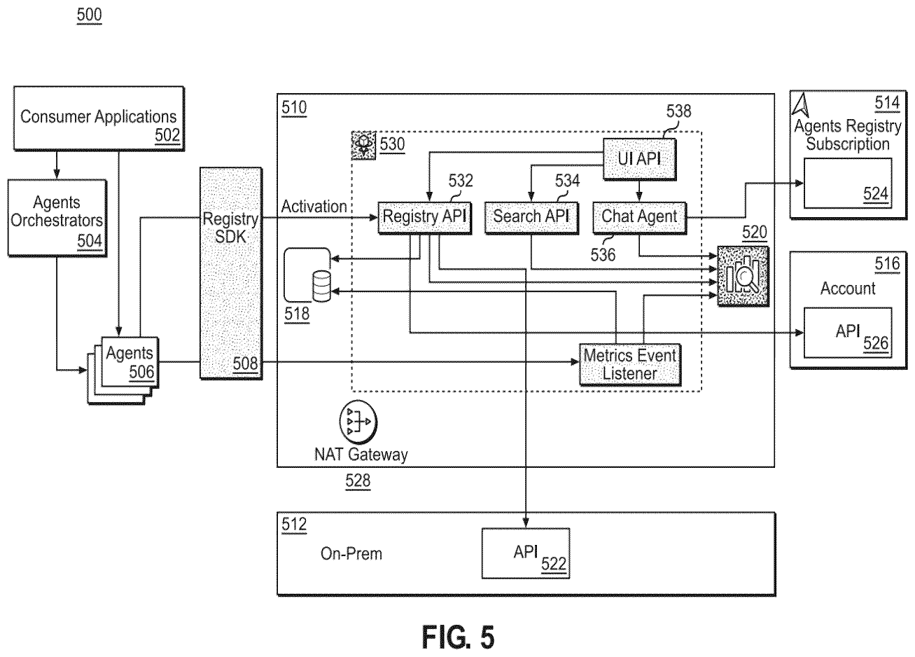

FIG. 5 depicts a configuration 500 of an implementation of an agent registry system according to the present invention(s).

As depicted in FIG. 5, configuration 500 may comprise a plurality of components, such as consumer applications 502. Consumer applications 502 may refer to software applications that may be locally and/or remotely implemented by one or more devices, such as one or more client devices from among client devices 204(1)-204(n).

Consumer applications 502 may utilize a software development kit of the agent registry system, namely registry SDK 508, to activate at least one from among agents 506 (and agents orchestrators 504) within the agent registry system of configuration 500. Registry SDK 508 may be configured to facilitate activation by transmitting agents 506 (and agents orchestrators 504) to module 510 for registration.

In configuration 500, module 510 may be a cloud (and/or server)-based agents registry platform that may include the following components: database 518, module 520, network address translation (NAT) gateway 528, and module 530. Additionally, agents 506 may comprise one or more agents (such as GenAI agents), agents orchestrators 504 may comprise software that orchestrates—according to at least one orchestration pattern—a plurality of agents (such as agents 506), database 518 may comprise a large (or global)-scale relational database system, module 520 may be an analytics engine of database 518, and module 530 may be a software container of module 510.

Accordingly, as depicted in FIG. 5, consumer applications 502 may utilize its interface with registry SDK 508 to activate agents 506 (and agents orchestrators 504) within the agent registry system of configuration 500. When consumer applications 502 activate agents 506 (and agents orchestrators 504), registry SDK 508 may respond by interfacing with module 530 via registry API 532 and mediating the activation. In turn, module 530 may register agents 506 (and agents orchestrators 504) within a relational database, such as database 518, via registry API 532.

Additionally, as depicted in FIG. 5, the cloud (and/or server)-based agents registry platform's container (module 530) may be made up of components that include a metrics event listener and various APIs, which may include registry API 532, search API 534 and a user interface (UI) API, namely UI API 538. The metrics event listener may receive metrics from registry SDK 508 when agents 506 are activated via registry API 532.

In turn, the metrics event listener may store the metrics within database 518 along with an association to agents 506. The metrics may comprise information about agents 506 (e.g., location within database 518, identification, size, etc.) and/or information about their activation(s) (i.e., date, time, duration, etc.). Additionally, the association may be an attribute of agents 506, such as at least one of the following attributes: the identification, the location within database 518, etc.

Module 530 may utilize search API 534 to search database 518 for agents 506 and/or for data that may pertain to agents 506, and UI API 538 may be utilized by a user (and/or consumer applications 502) to interface with users and/or client devices via a UI such as a graphical user interface (GUI). Additionally, UI API 538 may be utilized to interface with module 510 via registry API 532 and/or search API 534. Moreover, the metrics event listener, registry API 532 and search API 534 may interact with database 518 via module 520, which may be an analytics engine.

After activation, UI API 538 may be utilized to instruct module 510 to deploy an agent (e.g., chat agent 538) that generates textual responses in response to corresponding queries that are received from users (and/or client devices) via UI API 538. As depicted in FIG. 5, module 510 may deploy at least one instance 524 of chat agent 538 to a computer network, such as agents registry subscription 514.

Agents registry subscription 514 may be a distributed computer network and/or a virtual computer network that subscribes to the services of module 510. Additionally, agents registry subscription 514 may comprise a plurality of virtual machines (VMs) and at least one hypervisor or virtual machine manager (VMM).

As depicted in FIG. 5, module 510 may deploy at least one instance 526 of an agent (e.g., API 526) that is configured to generate video in response to corresponding queries that are received from users (and/or client devices) via UI API 538, and module 510 may deploy instance 526 to a computer network, such as account module 516, which may have an account with module 510. In configuration 500, API 526 may be an agent that comprises an interface that may generate video and receive the above-mentioned corresponding queries for such video.

Thereafter, the target computer network (e.g., agents registry subscription 514 and/or account 516) may utilize (e.g., query) deployed agents (e.g., agent 524 and/or API 525, respectively) to generate content (e.g., text, video, etc.).

As part of managing generative AI agents and workflows with agent registry, this disclosure provides innovations in areas that include: centralized repository; metadata management; discovery and deployment; agent definition, validation and activation; version management processes; metric collection; agent development lifecycle, ownership, and delegations.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Therefore, applications of the present disclosure are not limited to electronic resource usage efficiency improvements and may be extended to provide a technical improvement to efforts in other technological areas.

Accordingly, although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of implementing a generative artificial intelligence (GenAI) agent intake and deployment depot, the method comprising:
receiving a first set of electronic transmissions that comprises a first set of code that implements a first GenAI agent which includes at least a first GenAI model that comprises a first set of algorithms which are configured to perform, collectively, a first set of tasks;
storing the first set of code within a GenAI repository;
indexing, within an electronic manifest of the GenAI repository, a first set of details that pertain to the first GenAI agent; and
utilizing at least a portion of the electronic manifest to provide, to at least one network device of an electronic communication network, access to at least the first GenAI agent from among a set of GenAI agents that is stored within the GenAI repository.

2. The method of claim 1, wherein providing the access comprises:
providing the first GenAI agent to the electronic communication network by performing at least one operation from among:
deploying a remote instance of the first GenAI agent to the at least one network device; and
interfacing, via at least one application programing interface (API), a local instance of the first GenAI agent with the at least one network device.

3. The method of claim 1, further comprising at least one from among:
authenticating the first GenAI agent after the first set of code is received; and
verifying, before an instance of the first GenAI agent is accessed, that the first GenAI agent has been authenticated.

4. The method of claim 1, further comprising:
delegating a first set of system resources to at least one instance of the first GenAI, wherein the first set of system resources comprises at least one from among at least one hardware resource and at least one software resource.

5. The method of claim 1, wherein providing the access comprises performing at least one operation from among:
permitting the at least one network device to instruct the first GenAI agent to generate and return a first set of responses to a first set of respectively corresponding queries that have been received from the at least one network device;
permitting the at least one network device to at least one from among test and evaluate at least one performance of the first GenAI agent; and
permitting the at least one network device to at least one from among:
search the GenAI repository for a GenAI agent from among the set of GenAI agents, and
deploy, from the GenAI repository, at least one instance of the GenAI agent to the at least one network device.

6. The method of claim 1, wherein providing the access comprises performing at least one operation from among:
permitting the at least one network device to generate an updated set of code by updating the first set of code according to at least one software patch that fixes at least one bug of the first GenAI agent; and
permitting the at least one network device to generate a second GenAI agent by modifying the first set of code.

7. The method of claim 6, further comprising:
propagating the software patch to at least one instance of the first GenAI agent to which the at least one network device has been provided the access.

8. The method of claim 1, further comprising:
orchestrating, according to at least one orchestration pattern, a plurality of GenAI agents to perform, collectively, at least one task.

9. The method of claim 1, wherein providing the access comprises:
utilizing a graphical user interface (GUI) to provide the at least one network device with the access,
wherein the GUI comprises at least one depiction of GenAI agent activity, and
wherein the GUI provides GenAI agent control by enabling each from among the at least one depiction to be selected and configured, individually.

10. The method of claim 1, wherein providing the access comprises:
permitting the at least one network device to wipe at least one instance of the first GenAI agent from at least one from among the GenAI repository and a set of network devices within the electronic communication network.

11. A system of implementing a generative artificial intelligence (GenAI) agent intake and deployment depot, the system comprising:
a processor; and
memory storing instructions that, when executed by the processor, cause the processor to perform operations that comprise:
receiving a first set of electronic transmissions that comprises a first set of code that implements a first GenAI agent which includes at least a first GenAI model that comprises a first set of algorithms which are configured to perform, collectively, a first set of tasks;
storing the first set of code within a GenAI repository;
indexing, within an electronic manifest of the GenAI repository, a first set of details that pertain to the first GenAI agent; and
utilizing at least a portion of the electronic manifest to provide, to at least one network device of an electronic communication network, access to at least the first GenAI agent from among a set of GenAI agents that is stored within the GenAI repository.

12. The system of claim 11, wherein when executed by the processor, the instructions cause providing the access to comprise:
providing the first GenAI agent to the electronic communication network by performing at least one operation from among:
deploying a remote instance of the first GenAI agent to the at least one network device; and
interfacing, via at least one application programing interface (API), a local instance of the first GenAI agent with the at least one network device.

13. The system of claim 11, wherein when executed by the processor, the instructions cause providing the access to comprise performing at least one operation from among:
permitting the at least one network device to instruct the first GenAI agent to generate and return a first set of responses to a first set of respectively corresponding queries that have been received from the at least one network device;
permitting the at least one network device to at least one from among test and evaluate at least one performance of the first GenAI agent; and
permitting the at least one network device to at least one from among:
search the GenAI repository for a GenAI agent from among the set of GenAI agents, and
deploy, from the GenAI repository, at least one instance of the GenAI agent to the at least one network device.

14. The system of claim 11, wherein when executed by the processor, the instructions cause providing the access to comprise performing at least one operation from among:
permitting the at least one network device to generate an updated set of code by updating the first set of code according to at least one software patch that fixes at least one bug of the first GenAI agent; and
permitting the at least one network device to generate a second GenAI agent by modifying the first set of code.

15. The system of claim 14, wherein when executed, the instructions cause the processor to perform further operations, which further comprise:
propagating the software patch to at least one instance of the first GenAI agent to which the at least one network device has been provided the access.

16. The system of claim 11, wherein when executed, the instructions cause the processor to perform further operations, which further comprise:
orchestrating, according to at least one orchestration pattern, a plurality of GenAI agents to perform, collectively, at least one task.

17. The system of claim 11, wherein when executed by the processor, the instructions cause providing the access to comprise:
utilizing a graphical user interface (GUI) to provide the at least one network device with the access,
wherein the GUI comprises at least one depiction of GenAI agent activity, and
wherein the GUI provides GenAI agent control by enabling each from among the at least one depiction to be selected and configured, individually.

18. A non-transitory computer-readable medium that implements a generative artificial intelligence (GenAI) agent intake and deployment depot, the computer-readable medium storing instructions that, when executed by a processor, cause the processor to perform operations that comprise:
receiving a first set of electronic transmissions that comprises a first set of code that implements a first GenAI agent which includes at least a first GenAI model that comprises a first set of algorithms which are configured to perform, collectively, a first set of tasks;
storing the first set of code within a GenAI repository;
indexing, within an electronic manifest of the GenAI repository, a first set of details that pertain to the first GenAI agent; and
utilizing at least a portion of the electronic manifest to provide, to at least one network device of an electronic communication network, access to at least the first GenAI agent from among a set of GenAI agents that is stored within the GenAI repository.

19. The computer-readable medium of claim 18, wherein when executed by the processor, the instructions cause providing the access to comprise performing at least one operation from among:
permitting the at least one network device to generate an updated set of code by updating the first set of code according to at least one software patch that fixes at least one bug of the first GenAI agent; and
permitting the at least one network device to generate a second GenAI agent by modifying the first set of code.

20. The computer-readable medium of claim 19, wherein when executed, the instructions cause the processor to perform further operations, which further comprise:
propagating the software patch to at least one instance of the first GenAI agent to which the at least one network device has been provided the access.
